(19) United States
(12) Patent Application Publication
(10) Pub. No.: US 2007/0291498 A1
(43) Pub. Date: Dec. 20, 2007

(54) ELECTROLUMINESCENT LAMP HAVING A FLEXIBLE FOIL LIGHT ELEMENT

(75) Inventors: Alexander Covasala, Esslingen (DE); Klaus Beutelschiess, Dettingen (DE); Thorsten Fink, Albershausen (DE)

Correspondence Address: REISING, ETHINGTON, BARNES, KISSELLE, P.C., P O BOX 4390, TROY, MI, 48099-4390, US

(73) Assignee: Schefenacker Vision Systems Germany GmbH, Schwaikheim (DE)

(21) Appl. No.: 11/762,535

(22) Filed: Jun. 13, 2007

(30) Foreign Application Priority Data
Jun. 14, 2006 (DE) 102006028216.7

(51) Int. Cl. G01B 13/18; G01B 21/22

(52) U.S. Cl. 362/460

(57) ABSTRACT

The invention relates to an electro-luminescent light element, in particular to a foil-shaped light element with a light emitting surface (34) for emitting light from a light pigment layer (16) arranged on a carrier (12). According to the invention the light element (10) is provided with an electrically conductive cover (30).

The invention relates to an electro-luminescent light element, in particular a foil-shaped light element according to the preamble of claim 1.

Light elements based on electro-luminescence are well known. In addition to light diodes, so-called LED's, large-area light elements are also known both on stiff as well as flexible carriers. In practice, foil elements produced based on thick-layer technology have proven, which are excited with fields of alternating voltage. Here, light pigments are embedded in a transparent, organic, or ceramic binder. The light pigments usually comprise binary compounds. The electric field is fed via structured electrodes, of which the frontal electrodes emitting the electro-luminescent radiation comprising a transparent, electrically conducting material layer, for example a very thin layer of metal or a transparent semiconductor, such as indium oxide or indium stannic oxide (ITO). The rear electrode comprises a conducting layer of metal. The light pigment layer arranged between the frontal and the rear electrode, if necessary having an additional insulating layer, together with this embedding medium forms the dielectric of a condenser, thus sometimes the term “light condenser” is used, as well. The light elements are non-linear constructive parts, with their parameters representing a function of voltage and frequency provided and which also depend on the environmental conditions, such as humidity and temperature.

Frequently the transparent electrode is a plastic (e.g., polyester) coated with indium oxide or indium stannic oxide, with the plastic serving as the carrier. The light pigment may comprise zinc sulphide, for example, which is doped with various metals, such as Au, Ag, Cu, GA, or Mn. The color of the light emitted and the conductivity of the light pigment layer are determined by the intensity and the composition of the doping. By a variation of the doping color ranges from blue through yellow can be achieved, depending on wavelength from approximately 480 nm to 580 nm, and mixed colors resulting by mixing the doping matter, for example the mixed color white. An insulating layer applied onto this light pigment layer, for example made from barium titanate, simultaneously acts as a reflector. Subsequently a back electrode, for example aluminum, carbon, or silver-lacquer is applied thereupon. Due to the fact that zinc sulphide is strongly hygroscopic encapsuling is provided, which comprises a material intensely hydrophobic. However, there are already pigment elements, in which zinc sulphide molecules are micro-capsuled, so that the hygroscopic features are less dominant. By the larger molecular distance the light intensity is slightly lower and not quite as homogenous. Such foil-shaped light elements can be cut, are extremely thin, highly flexible, and cost effective. Lamination is not necessary any more, however it additionally increases moisture protection.

Electro-luminescent light elements are generally operated with relatively high alternating voltage up to 300 Volts and typical frequencies ranging from 200 Hz to 3 kHz. Voltage and frequency can influence the illumination and/or the light intensity. Here, both the light element as well as the feeders act as transmitting antennas, which radiate an electromagnetic power according to the alternating voltage fed to the light element. This may lead to problems with the electromagnetic tolerance (EMV), particularly in the use of light elements in the motor vehicle field. In order to improve the EMV-tolerance of such light elements and to reduce or eliminate the emission of electromagnetic radiation expensive electronic filters and inverters are used.

The object of the invention is to provide an electro-luminescent light element with an improved EMV-tolerance, which is particularly suitable for the use in motor vehicles. The object is attained according to the invention by the features of the independent claim. Advantageous embodiments and advantages of the invention are discernible form the other claims and the description.

The electro-luminescent light element according to the invention is provided with a light emitting surface for emitting light from a light pigment layer and is provided with an electrically conductive cover. The cover surrounds the light element at least sectionally. The light element is particularly a foil-shaped light element with an electro-luminescent foil. The electrically conducting cover forms a shield against the emission of electromagnetic radiation. The electric conductivity is preferably in the field of metallic conductivity or in the field of electric conductivity of high-doped semi-conductors. The light element can be covered entirely or only partially. The cover may be highly flexible or stiff as well. If necessary, sections may be provided or doped with electrically conducting particles or also be coated in an electrically conducting manner. By the shielding effect of the cover an EMV-protective switch of electronic components connected to the light element can be simplified or even omitted. This way, for example, a level of effectiveness of an inverter supplying the light element with electric power can be improved and its thermal stress accordingly reduced. Overall, this allows cost savings in the design of the light element and/or the supplying electronics.

An advantageous embodiment results when the cover is embodied transparent at least in the area of the light emitting surface. This way the function of the light element remains advantageously unaffected in spite of the cover. In the simplest case the cover is provided with one or more openings in this area. For example, a clear cover with one or more respective openings at the light emitting surface is possible.

Advantageously the cover can be provided at least in the area of its light emitting area with a transparent material so that the light emission of the light emitting surface remains unaffected. This transparent material may be arranged over a large surface area, for example the entire surface of the cover. Beneficially the cover itself is formed in this area from a transparent material, for example a foil. If necessary, the transparent material may be embodied thinner at the light emitting area than in the areas of the cover surrounding it.

The transparent material may be formed in a layer applied onto the cover or in form of a foil. A layer may be applied onto the cover, for example, via vacuum deposition methods, such as steaming or sputtering. It may also be provided as a freely supported thin foil, which is connected to the cover and covers the light emitting area, at least partially.

Beneficially the transparent material is embodied electrically conducting. Preferably a transparent, preferably doped semi-conductor, such as indium oxide or indium stannic oxide is used as a coating, with its electric conductivity being equivalent to the conductivity of metallic material. However, a very thin metallic layer may also be provided, which is still sufficiently transparent, however already has a sufficient electric conductivity.

Beneficially the cover is provided with a ground connection so that the emission of electro-magnetic radiation during operation of the light element is effectively prevented. When the light element is used as a motor vehicle light an electric connection to the motor vehicle ground is beneficial.

The shielding is particularly effective when the cover can enclose the light element essentially in its entirety. Essentially in its entirety means that openings are provided for electric feeding wires, and/or at least 90% of the area of the light element is covered by the cover.

Particularly beneficial is the cover comprising a flexible foil. Here, an adjustment of the cover to the light element is possible in a simple manner. Advantageously the foil may be formed from the same material as the carrier foil of the light element, on which the light pigment layer is arranged. Here, the foil may be provided with an electrically conducting transparent coating at least its light emitting area, so that its light emission remains unaffected. The foil may be coated over its entire area with an electrically conducting coating. The coating may advantageously be applied in a band application process, so that [sic]

An electric component for supplying the light element, in particular an inverter, may advantageously be arranged inside the cover, which allows it to be subject to the shielding effect. Furthermore, feeding lines have been beneficially shortened, which reduces the effect of the antenna. It is also possible to arrange the inverter on the cover. By this arrangement at least the feeding lines can be shortened and thus the emission of electromagnetic radiation can be reduced during the operation of the light element.

Advantageously the cover can be embodied in a self-adhesive manner, which allows easy fastening on the light element. The cover can also serve advantageously as a protective cover against environmental influences, in particular against moisture. If necessary, then the encapsuling of moisture-sensitive components of the light element can be waived. It is known that the light pigment layer degrades by the influence of moisture.

Particularly preferred the light element is embodied as a vehicle light. It may be a passenger cabin light or a background lighting of displays in the vehicle. Furthermore, the light element may also be integrated in the other lights of the vehicle.

In the following, additional advantages and details of the invention are explained in greater detail using a preferred exemplary embodiment described in the drawing, without being limited to this exemplary embodiment.

It shows:

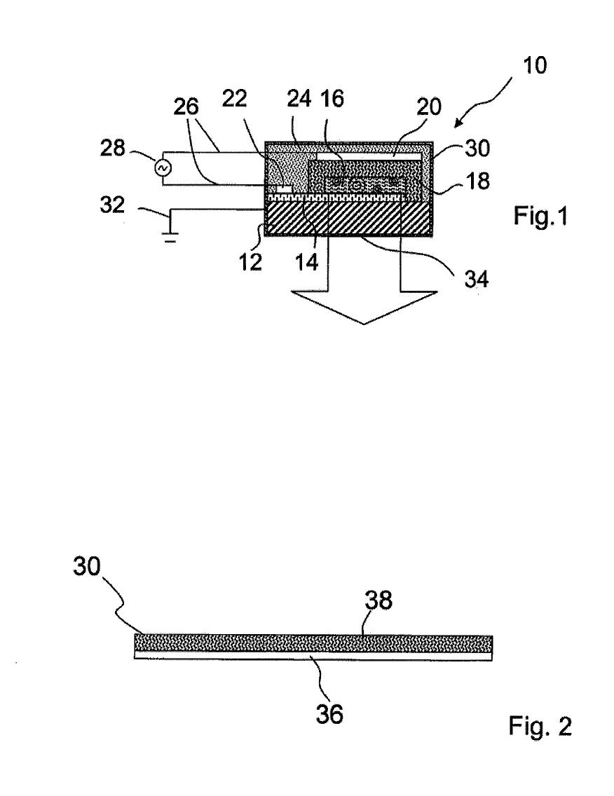

FIG. 1 schematically an electro-luminescent light element in a cross-section;

FIG. 2 a detail of a preferred cover for a light element according to the invention, and

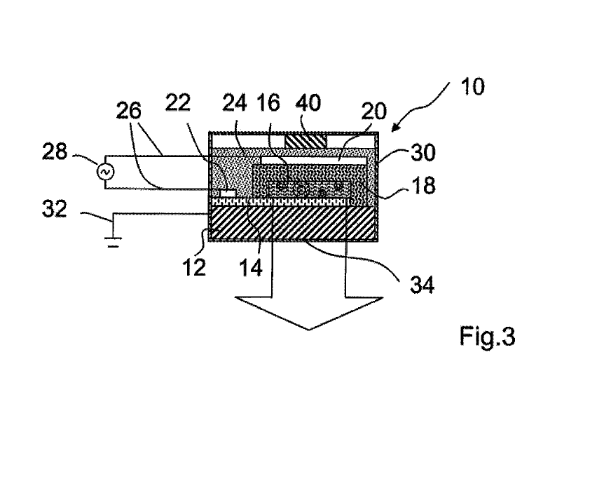

FIG. 3 schematically an electro-luminescent light element in a cross-section arranged in a cover having an electronic component

In the figures constant or identically effective elements are generally identified with the same reference characters.

FIG. 1 shows schematically a preferred electro-luminescent light element 10 in a cross-section in order to illustrate the invention. According to the invention, a flexible, conducting cover 30 surrounds the light element 10. Due to its high electric conductivity the cover 30 acts as a Faraday cage and prevents the emission of electromagnetic radiation from the light element 10 into the environment. Preferably the light element 10 is embodied as an electro-luminescent foil-shaped light element. Such foil-shaped light elements can advantageously be used as flat lights. Preferably such a light element 10 is used as a vehicle light, for example in the passenger cabin or at or in an exterior light, for example also in combination with other lighting means, such as light diodes or light bulbs.

The interior design of the light element 10 is largely conventional. On a carrier 12, which may be embodied stiff or in the form of a foil, in particular as a PET foil (PET=polyethylene terephthalate) a transparent electrode layer 14 is arranged as a frontal electrode. The electrode layer 14 can be electrically contacted via an electrically conducting structure 22. The electrode layer 14 is preferably formed from doped indium oxide or indium stannic oxide.

The electrode layer 14 carries a light pigment layer 16, which is responsible for the electro-luminescent features of the light element 10, surrounded by an insulating layer 18, for example made from barium titanate. On the insulation layer 18 an electrode layer 20 follows as the back electrode. The electrode layer 20 with the insulation layer 18 and the light pigment layer 16, for example provided with ZnS, as well as the wiring structure 22 can be capsuled with a protective layer 24. The protective layer 24 may comprise a suitable protective lacquer and/or a unilaterally or bilaterally self-adhesive protective foil made from PP (polypropylene) or PET. In the latter case the protective layer 24 may even be a component of the cover 30.

The cover 30 is largely shown transparent in the area of the light emitting surface 34. The arrow indicates the light emitting direction of the light element 10.

The electrode layer 20 and the electric wiring structure 22 are connected to a power supply 28 via supply lines 26, which provide alternating voltage with a desired frequency for supplying the light element 10.

The cover 30 is provided with a ground connection 32, which in the case it is used as a vehicle light is preferably the vehicle ground.

FIG. 3 shows a preferred embodiment of the invention, in which an electronic component 40, preferably an inverter, is arranged within a cover 30 to supply the light elements 10. The other components are equivalent to those in FIG. 1, which are only referenced to in order to avoid any unnecessary repetitions.

The light element 10 can be operated with alternating voltage having an effective value of approx. 50-300 V_{eff} and 100-2000 Hz. This alternating voltage is preferably provided by a special inverter, sometimes also called converter, which is adjusted to the respective light element 10. Here, the electric features and the dimensions of the light element 10 are considered. At the input side, at the inverter, for example a vehicle voltage is supplied, at the output side the alternating voltage signal is provided to the electro-luminescent light element 10.

FIG. 2 explains some details of a preferred cover 30. A transparent material in the form of a transparent and electrically conductive cover 38 is arranged on a highly flexible foil 36.

Preferably the conductivity of the cover is in the range of the one of metallic materials. Beneficially, the specific resistance is lower than 1·10⁻⁶ Ωm. Beneficial are, for example doped transparent semi-conductors, such as indium oxide or indium stannic oxide.

On the side, facing away from the cover 38, the foil 36 is provided with an adhesive and thus forms a self-adhesive cover 30. The foil 36 is formed from the same material as the carrier 12 of the light element 10, for example. Using the cover 30, the entry of moisture but also an undesired effect of UV-radiation to the sensitive light pigment layer 16 can be avoided. By the self-adhesive features of the cover 30 it can easily be applied onto the foil-shaped light element 10, using suitable lamination techniques, known per se.

### LIST OF REFERENCE CHARACTERS

10 light element

12 carrier

14 electrode layer

16 light pigment layer

18 insulation layer

20 electrode layer

22 electrically conducting structure

24 protective layer

26 voltage supply

28 AC-supply

30 cover

32 ground connection

34 light emitting surface

36 foil

38 coating

40 electric component

1. An electro-luminescent light element, in particular a foil-shaped light element, having a light emission area (34) for emitting light from a light pigment layer (16) arranged on a carrier (12) characterized by an electrically conductive cover (30).

2. A light element according to claim 1, characterized in that the cover (30) is embodied transparent at least in the area of the light emission surface (34).

3. A light element according to claim 1 or 2, characterized in that the cover (30) is provided with a transparent material (38) in the area of the light emitting surface (34).

4. A light element according to claim 3, characterized in that the transparent material (38) is electrically conductive.

5. A light element according to one of the previous claims, characterized in that essentially the cover (30) completely covers the light element (10).

6. A light element according to one of the previous claims, characterized in that the cover (30) comprises a flexible foil (36).

7. A light element according to one of the previous claims, characterized in that an electric component (40) is arranged inside the cover (30) as the voltage supply.

8. A light element according to one of the previous claims, characterized in that an electric component (40) is arranged on the cover (30) for supplying voltage.

9. A light element according to one of the previous claims, characterized in that the cover (30) is embodied in a self-adhesive manner.

10. A light element according to one of the previous claims, characterized in that the cover (30) is provided with a ground connection (32).

11. A light element according to one of the previous claims, characterized in an embodiment as a vehicle light.
